(19) United States
(12) Patent Application Publication
(10) Pub. No.: US 2006/0209837 A1
(43) Pub. Date: Sep. 21, 2006

(54) Method and apparatus for dynamically managing a retransmission persistence

(76) Inventors: Jai Yong Lee, Seoul (KR); Je Chan Han, Seoul (KR)

Correspondence Address: QUALCOMM INCORPORATED, 5775 MOREHOUSE DR., SAN DIEGO, CA, 92121, US

(21) Appl. No.: 11/156,024

(22) Filed: Jun. 16, 2005

(30) Foreign Application Priority Data
Mar. 16, 2005 (KR) KR-10-2005-002172

(51) Int. Cl. H04L 12/56

(52) U.S. Cl. 370/394

(57) ABSTRACT

In order to solve a problem of an existing ARQ scheme using a fixed retransmission persistence, the present invention provides a method of dynamically managing a retransmission persistence of an ARQ according to an amount of data stored in a buffer of the ARQ, or according to time (transmission delay time) until data frame inputted from a buffer input terminal of a transmission node receives an ACK signal from a receiving node. That is, when an amount of data waiting the transmission at the buffer of the transmission terminal of the ARQ is small, a high persistence is allowed, and when the amount of data is large, only a relatively smaller persistence is allowed. Especially, when the amount of data stored in the buffer of the ARQ exceeds a congestion threshold, a retransmission is not allowed. The amount of traffic imposed on the ARQ is based on the amount of data stored in the buffer, and the number of retransmissions for one frame is adjusted in inverse proportion to the amount of data stored in the buffer.

### FIELD OF THE INVENTION

The present invention relates to a method and apparatus for dynamically managing a retransmission persistence according to system conditions to resolve the problem of an existing ARQ scheme using a fixed retransmission persistence.

### BACKGROUND OF THE INVENTION

ARQ (Automatic Retransmit Request), FEC (Forward Error Correction), or hybrid ARQ using the two have been considered in order to ensure the reliability of a wireless link [1], [3]. An ARQ detects a frame loss at a link layer and implements a retransmission function. Whether or not the transmitted frames are lost is detected by an acknowledgement signal (Ack) or a polling which is transmitted from a retransmission timer or a receiver. Thereby the ARQ can recover the lost frames to effectively ensure the reliability of a wireless link with respect to an upper transfer protocol [1]. However, since the existing ARQ always uses a fixed retransmission persistence, it has a drawback that it cannot efficiently respond to state variations of a network. In particular, when a wireless link is in a congestion, a number of retransmissions decrease the performance of the link layers considerably. This is a serious problem in that the performance of the ARQ of the link layers affects adversely an overall throughput (e.g., TCP throughput) of upper layers. Accordingly, the present invention provides a method for dynamically managing a retransmission persistence in an ARQ system in consideration of the number of frames stored in a buffer. Since the proposed method can limit a maximum transmission delay time due to retransmission of the ARQ and reflect the state of the wireless link properly, the proposed method can increase the efficiency of the ARQ system considerably.

The present invention relates to a method and apparatus for dynamically managing a retransmission persistence of a transmission node based on a buffer size and/or a delay time in an ARQ system.

ARQ transmission schemes can be largely classified into a stop-and-wait ARQ scheme and a sliding window ARQ scheme [4].

FIG. 1(a) shows a stop-and-wait ARQ scheme. The stop-and-wait ARQ scheme transmits one frame at a time, and then, after confirming that the frame has been successfully transmitted, transmits a next frame. The stop-and-wait ARQ scheme is easy to implement, but the efficiency is low since it cannot transmit frames until it, after transmitting one frame, receives an ACK for the transmitted frame. In the sliding window ARQ scheme, a transmitter manages a transmission window to many frames successively, because when a sufficiently large transmission window is used, the sliding window ARQ scheme is very efficient. By contrast, the sliding window ARQ scheme may be relatively complex to implement since it must assign a sequence number for each frame. Exemplary sliding window ARQ schemes are GBN (Go-back-N) ARQ scheme and SR (Selective-Repeat) ARQ scheme [6].

FIG. 1(b) shows a GBN ARQ scheme. When a transmitter receives an NAK, then it goes back to a block, where an error occurs, to retransmit all of its subsequent blocks.

FIG. 1(c) shows an SR ARQ scheme. When a receiver receives an NAK, then it finds an error block to retransmit only a corresponding block. Accordingly, the SR ARQ scheme has a good transmission efficiency, but it requires more complex circuitry and a larger volume of buffer compared with other ARQ schemes, and the receiver should rearrange data.

The performance of an ARQ is evaluated by transmission reliability, delay and delay jitter, and transmission rate, which have a lot to do with the frame transmission scheme and the retransmission persistence. The term “retransmission persistence” refers to a degree that an ARQ tries the retransmission, and it is generally defined by time assigned to process one frame. When a propagation delay of a link is constant, it can be set by the number of retransmission. The larger retransmission persistence is the higher link reliability, but the propagation delay and jitter of the frames due to frequent retransmission increase rapidly. Accordingly, it is most important to determine an appropriate retransmission persistence in order to meet the efficient performance of the link layers.

The ARQ can be classified into a perfectly-persistence ARQ, a high-persistence ARQ, and a low-persistence ARQ according to the size of retransmission persistence [1], [2], [3], [6].

The perfectly-persistence ARQ tries to retransmit the frames infinitely until the frame transmission succeeds, and ensures the link reliability completely [1], [2]. However, when the frame loss occurs successively due to a bad link since there is no limit in the frame retransmission, a large delay and jitter occurs and a maximum transmission delay of the link cannot be met. In particular, the delay and jitter due to the retransmission of the link layers may have an effect on the performance of an upper transfer protocol. In case of TCP, a large jitter at the link layers may degrade the accuracy of a TCP retransmission timer, and at the worst case, it may cause a retransmission time out (RTO) to thereby reduce the TCP transmission rate rapidly [5], [7]. In addition, for services such as audio or video services, which are more sensitive to a delay or jitter than to the transmission reliability, an excessive retransmission at the link layers may decrease the service quality [1].

In case of the low-persistence ARQ, since the retransmission persistence of the frames is set as a small value from 2 to 5, the delay at the link layers is limited to somewhat of a small value, and thereby the effect on the upper transfer protocol is also small, but it cannot ensure the link reliability as sufficiently as the perfectly-persistence ARQ does.

Using a fixed retransmission persistence is not suitable for the Internet network in which the communication circumstances changes frequently. When an amount of traffic is small, many times of retransmissions can be made to ensure a high reliability of the link. As an amount of traffic increases, the performance of the ARQ varies sensitively according to the state of the wireless link. When the frame loss rate of the link is low, the ARQ can successfully transmit the frames through one or two retransmissions. By contrast, when the frame loss rate of the link is high, a plurality of retransmissions are required, and this leads to a rapid increase of the propagation delay and jitter at the link layers. This is because a longer time is required to process one frame so that the service rate of the ARQ is decreased.

In addition, if an amount of data accumulated in the ARQ buffer increases more rapidly, the vicious circle that the waiting delay increases continues. Using a small retransmission persistence is suitable in an overload state of the ARQ since it can prevent such phenomenon somewhat, but even when an amount of data which wait for the transmission in the buffer of an ARQ transmission terminal is small, a sufficient link reliability cannot be ensured. Particularly, the degradation of the throughput due to the frame retransmission in congestion aggravates the congestion, and results in the loss of data inputted into a transmission node without being tried to be transmitted. In a congestion state, when many data which are not processed immediately are stored in the buffer of a transmission node, and the buffer reaches the limit, most of the frames to be inputted are tail-dropped at the end of the buffer.

Accordingly, a method and apparatus capable of dynamically managing a retransmission persistence according to the system conditions are needed.

### SUMMARY OF THE INVENTION

In order to resolve a problem of an existing ARQ scheme using a fixed retransmission persistence, the present invention provides a method of setting a retransmission persistence of an ARQ according to an amount of data stored in a buffer of the ARQ, or according to time (transmission delay time) until data frame inputted from a buffer input terminal of a transmission node receives an ACK from a receiving node. That is, when an amount of data which wait for the transmission in a buffer of an ARQ transmission terminal is small, a high persistence is allowed, and when the amount of data which wait for the transmission in a buffer of an ARQ transmission terminal is large, only a relatively low persistence is allowed. Especially, when the amount of data stored in an ARQ buffer exceeds a congestion threshold, a retransmission is not allowed. An amount of traffic in the ARQ is based on the amount of data stored in the buffer, and the number of retransmissions for one frame is adjusted in inverse proportion to the amount of data stored in the buffer.

### BRIEF DESCRIPTION OF THE DRAWINGS

FIG. 1(a) shows a stop-and-wait ARQ scheme.

FIG. 1(b) shows a GBN ARQ scheme.

FIG. 1(c) shows an SR ARQ scheme.

FIG. 2 is a flow chart showing a method of managing a retransmission persistence according to one embodiment of the present invention.

FIG. 3 is a flow chart showing a method of managing a retransmission persistence according to another embodiment of the present invention.

FIG. 4 is a flow chart showing a method of managing a retransmission persistence according to yet another embodiment of the present invention.

FIG. 5 shows one example for managing a retransmission persistence in a stop-and-wait ARQ system according to one embodiment of the present invention.

FIG. 6 shows a constitution of a transmission node comprising an apparatus for managing a retransmission persistence according to one embodiment of the present invention.

FIGS. 7(a)-(c) show the results of simulations performed at a stop-and-wait ARQ to analyze the performances of an existing error control method and an error control method according to the present invention.

FIGS. 8(a)-(c) show the results of simulations showing the relationship among reliability, delay time and average buffer length with respect to packet error rates in an RLP connection.

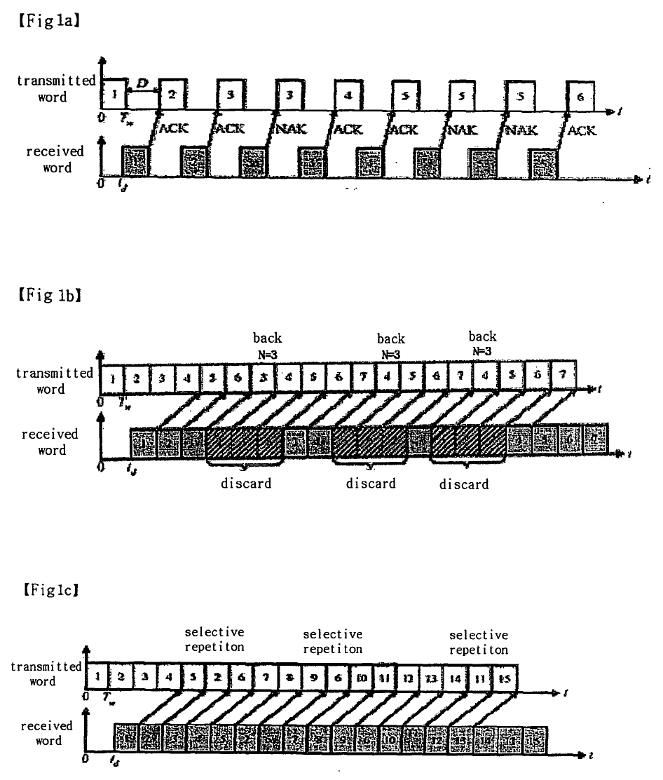

### DETAILED DESCRIPTION OF THE PREFERRED EMBODIMENTS

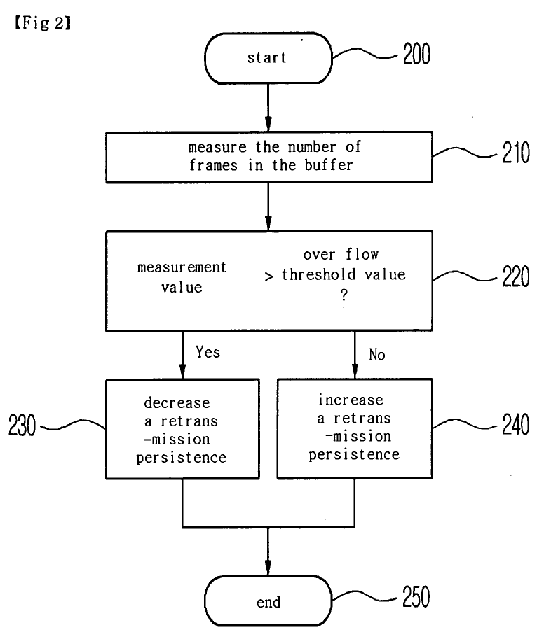

FIG. 2 is a flow chart showing a method for managing a retransmission persistence according to one embodiment of the present invention.

Referring to FIG. 2, by comparing the number of frames in the buffer of a transmission node with an overflow threshold, when the number of the frames in the buffer exceeds the overflow threshold, the retransmission persistence is reduced, and if not, the retransmission persistence is increased.

At step 200, a mechanism for managing the retransmission persistence is initiated, and the mechanism is automatically initiated at predetermined time intervals, or manually initiated according to a user's request.

At step 210, the number of frames in the buffer is measured, and the result is compared with the predetermined value of step 220. The predetermined value is one (overflow threshold) that is set in order to prevent the overflow of the buffer.

As the result of the comparison, when the number of frames in the buffer exceeds the overflow threshold, the retransmission persistence is reduced (step 230), and when the number of frames in the buffer is less than the overflow threshold, the retransmission persistence is increased (step 240).

Then the above processing terminates at step 250, and if the predetermined time interval arrives, or if there is a user's request, the above processing resumes at step 200.

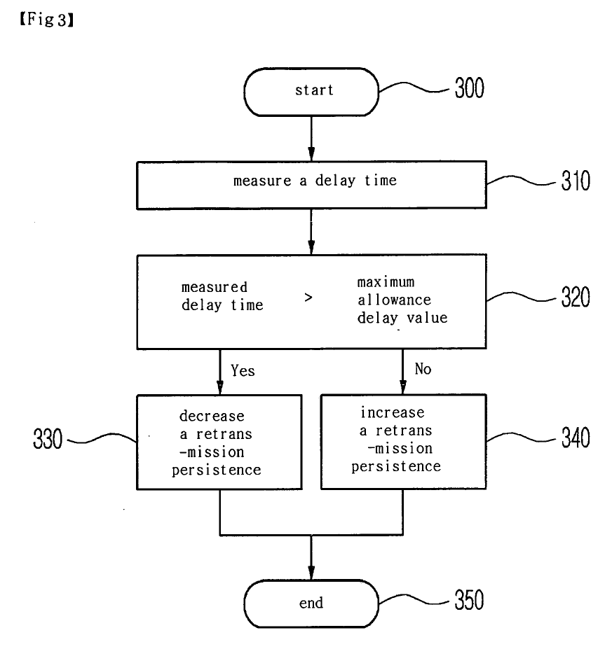

FIG. 3 is a flow chart showing a method for managing a retransmission persistence according to another embodiment of the present invention.

Referring to FIG. 3, a mechanism is disclosed wherein the delay time is measured or monitored, and if the delay time exceeds the retransmission persistence, the retransmission persistence is reduced, and otherwise, the retransmission persistence is increased.

At step 300, a mechanism for managing the retransmission persistence is initiated, and the mechanism may be automatically initiated at predetermined time intervals, or may be manually initiated by a user's request.

At step 310, a delay time is measured. The measurement of the delay time may be performed by two ways.

The first way is to measure the delay time based on the number of frames in the buffer.

In case of the stop-and-wait ARQ scheme, if the number of frames in a buffer is n, the retransmission persistence is p, and the round trip delay between the transmission node and the receiving node is r, then the delay time can be estimated as n*p*r.

In case of the SR ARQ scheme, the delay time may be estimated in consideration of the number of frames in the buffer, the number of frames in a retransmission buffer, the round trip delay between the transmission node and the receiving node, and the resequencing delay which should be waited in order to transmit the received frames to an upper layer (e.g., TCP).

The second way is to directly measure the delay time by monitoring the delay time of a previously transmitted frame.

That is, in order to estimate a maximum delay time of n-th frame, the second way monitors the delay time of the frame which has been transmitted previously and successfully received (ACK was received), and then estimates the delay time of n-th frame based on the measured value.

The delay time, which was measured at step 310, is compared with a maximum allowance delay value at step 320.

The term “maximum allowance delay value” refers to a individually prescribed value according to the kind of respective data and to whether or not it is a real-time communication.

For example, in case of a real-time communication requiring a quick signal processing rather than an accurate signal processing, the maximum allowance delay value is set smaller, and in case of a communication requiring an accurate signal processing rather than a quick signal processing, the maximum allowance delay value is set large.

As a result of the above-described comparison, when the measured delay time exceeds the maximum allowance delay time, the retransmission persistence is reduced (step 330), and when the measured delay time is less than the maximum allowance delay time, the retransmission persistence is increased (step 340).

Then the above-described processing terminates, and if the predetermined time intervals arrive, or if there is a user's request, the processing resumes at step 300.

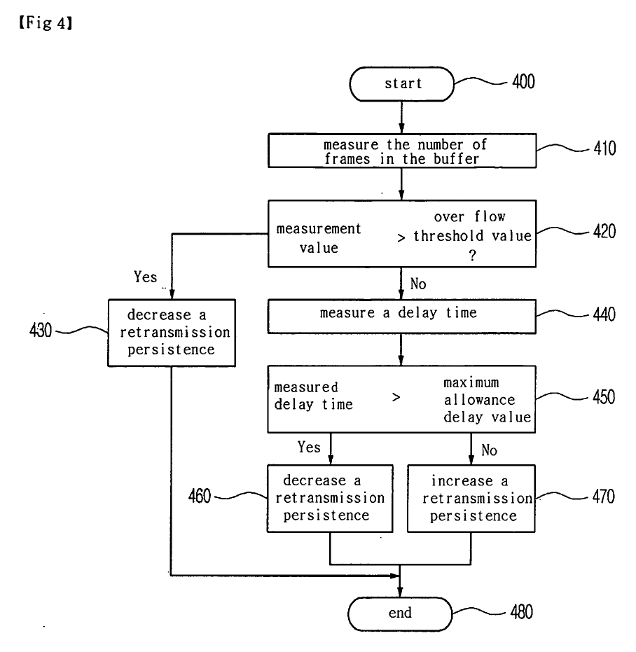

FIG. 4 is a method for managing a retransmission persistence according to yet another embodiment of the present invention, which is an embodiment combining the methods shown in FIGS. 2 and 3.

At step 400, the mechanism for managing the retransmission persistence is initiated, and the mechanism may be automatically initiated at predetermined time intervals, or may be manually initiated by a user's request.

At step 410, the number of frames in the buffer is measured, and the resulting value is compared with the predetermined value at step 420. The predetermined value is a value (i.e., overflow threshold) which is set in order to prevent the overflow of the buffer.

As a result of the comparison, when the number of frames in the buffer exceeds the overflow threshold, the retransmission persistence is reduced (step 430), and it terminates at step 480. As a result of the comparison, when the number of frames in the buffer is less than the overflow threshold, the delay time is estimated at step 440, and the estimated delay value is compared with the maximum allowance delay value at step 450.

When the estimated delay value exceeds the maximum allowance delay value, the retransmission persistence is reduced at step 460. When the estimated delay value is less than the maximum allowance delay value, the retransmission persistence is increased at step 470.

Then the above-described processing terminates at step 480, and if the predetermined time intervals arrive, or if there is a user's request, the processing resumes at step 400.

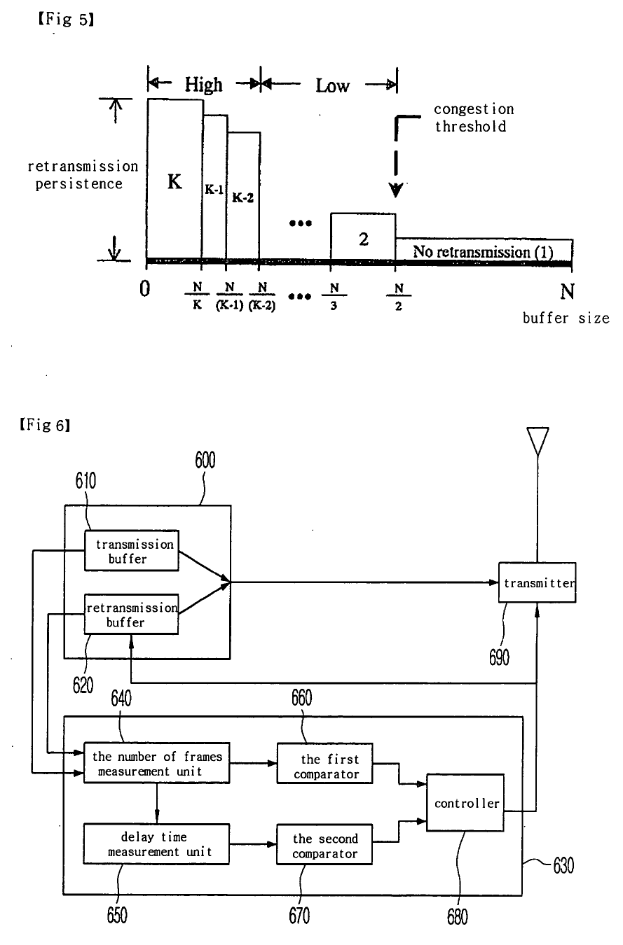

FIG. 5 shows one embodiment for managing a retransmission persistence in the stop-and-wait ARQ system according to one embodiment of the present invention.

Referring to FIG. 5, the size of buffer is set as N, the maximum retransmission persistence is set as K, and the overflow threshold is set as N/2.

Also, the retransmission persistence is dynamically managed according to the number of frames in the buffer, and for example, when the number of frames in the buffer is between N/3 to N/2, the retransmission persistence is set as 2.

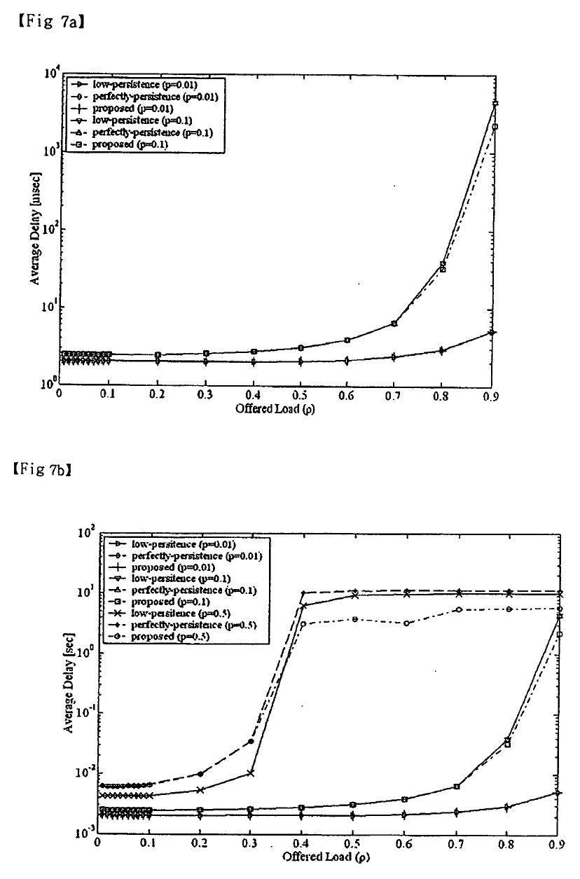

FIG. 6 shows the constitution of a retransmission node comprising an apparatus for managing the retransmission persistence according to one embodiment of the present invention.

FIG. 6 includes a transmission buffer 600, a retransmission persistence management unit 630, and a transmitter 690.

The transmission buffer 600 includes a transmission buffer 610 and a retransmission buffer 620.

The stop-and-wait ARQ system may omit the use of the retransmission buffer. Meanwhile, those skilled in the art will appreciate that the frames in the retransmission buffer are transmitted in advance, prior to the frames in the transmission buffer in the SR ARQ system.

The retransmission persistence management unit 630 includes the number of frames measurement unit 640, a delay time measurement unit 650, a first comparator 660, a second comparator 670, and a controller 680.

The number of frames measurement unit 640 counts the number of frame in the transmission buffer and the number of frames in the retransmission buffer, and the resulting value is provided to the first comparator 660 and the delay time measurement unit 650.

The first comparator 660 compares the resulting value with a first threshold (overflow threshold), and provides the comparison result to the controller 680.

The delay time measurement unit 650 measures the delay time estimation based on the number of the frames which are received from the number of frames measurement unit 680. The second comparator compares the delay time estimation with the second threshold (maximum allowance delay time), and then provides the comparison result to the controller 680.

According to the first comparison resulting value and the second comparison resulting value, the controller 680 provides control signals of managing the retransmission persistence to the buffer 600 and/or the transmitter 680.

When the first comparison resulting value exceeds the first threshold, the controller generates a control signal of reducing the retransmission persistence, and when the first comparison resulting value is less than the first threshold, the controller adjusts the retransmission persistence according to the second comparison resulting value.

Referring to FIG. 6, the delay time is determined based on the number of frames in the buffer, but in yet another embodiment, the delay time measurement unit 650 can estimate the delay time by monitoring the actual delay time of the frames which have been previously transmitted (i.e., the time from the input time of the buffer input terminal to the time of receiving ACK signals from the receiving node), not based on the number of frames in the buffer.

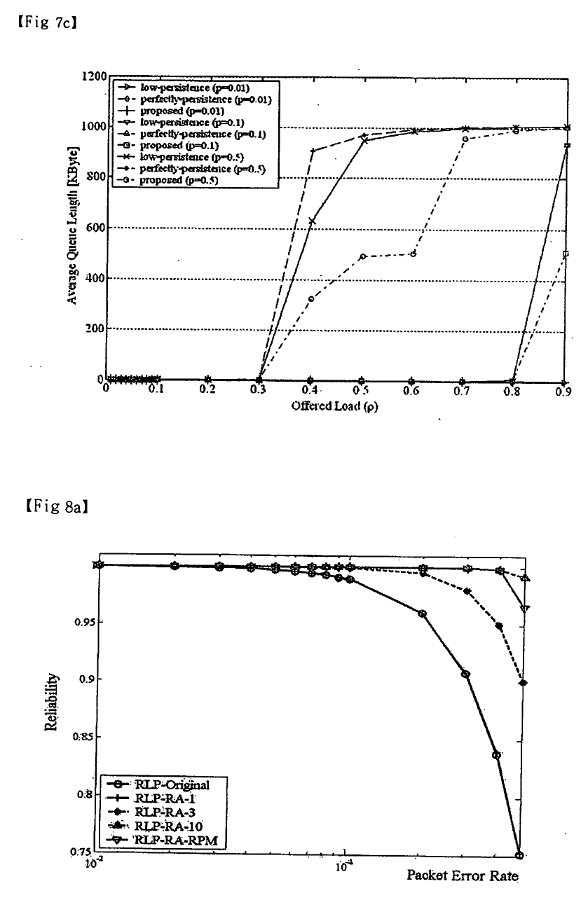

FIGS. 7(a)-(c) show the resulting value simulated in the stop-and-wait ARQ in order to anaylze the performances of the existing error control method and the proposed method. The setting of the retransmission persistence does not limit its size for the perfectly-persistence ARQ, and the low-persistence ARQ is set as 2 to perform the retransmission twice. The size of the retransmission persistence of the proposed method was set as shown in FIG. 5. It was presumed that the frame throughput in the simulation circumstance is 2 Mbps, and that the time taken when one frame is normally transmitted until an ACK is received from the receiver (i.e., Round Trip Time: RTT) is constant as 2 ms. The loss of the frames can be detected only by the time-out of the timer of the transmitter. At this time, the size of the timer is set by twice the frame transmission RTT. The size of the buffer of the receiver and the congestion threshold of the proposed method are set as 1024 kbytes and 512 kbytes, respectively, and it was presumed that the frames are lost randomly at the wireless link. The traffic imposed on the receiver occurs as a poisson model, and the size of the frames was set constantly as 512 bytes. The offered load is defined as the ratio of traffic which enters into the transmitter in comparison with the frame throughput, and the simulation was performed while varying the traffic load. Since the proposed method has a relatively large retransmission persistence when the traffic load is small, when the frame loss rate of the wireless link is less than 0.1, the proposed method exhibits a performance close to the perfectly-persistence ARQ in terms of the transmission reliability.

Average delay time, as shown in FIG. 7(a), exhibits the same size among the low-persistence, perfectly-persistence, and the proposed method when the frame loss rate is as low as 0.01 (p=0.01), and when the frame loss rate is 0.1 (p=0.1), the average delay times in the proposed method gets smaller than the low-persistence ARQ and the perfectly-persistence ARQ as the traffic amount imposed on the transmitter gets larger. This is because the amount of data stored in the buffer of the transmitter becomes larger as the traffic amount added to the transmitter increases, the retransmission persistence is set small to allow only the retransmission of a smaller number of frames than a method having a fixed retransmission persistence. FIG. 7(b) shows an average delay time of the three error control methods when the frame loss rate of the wireless link is very high as 0.5. The two methods using a fixed retransmission persistence, even when the traffic load is relatively as small as 0.4, experiences a rapid decrease in the performance in terms of the transmission delay and reliability. That is, since more than two times of transmission is needed in order to transmit one frame successfully, the transmission delay is rapidly increased, and the two methods fall into the congestion (i.e., buffer overflow). In contrast, the proposed method, when the traffic load is less than 0.4, maintains a larger retransmission persistence than the low-persistence ARQ, and provides a reliability close to the perfectly-persistence ARQ, and the transmission delay does not exceed the amount of which is several times larger than the link transmission delay (RTT). The proposed method decreases the retransmission persistence, as the traffic load increases from 0.4 to 0.6, to perform only one time of retransmission, thereby reducing the transmission delay by around 50% of the low-persistence ARQ.

FIG. 7(c) shows that the congestion occurs in the proposed method when the traffic load is greater than 0.7, and the proposed method allows a more stable operation than the existing fixed retransmission persistence method while the traffic load is 0.4 to 0.7.

TABLE 1 below shows the performance (reliability) of the three methods according to the frame loss rates of the wireless link when the traffic load is 0.8. When the frame loss rate is less than 0.1, the proposed method and the perfectly-persistence ARQ, which maintain a relatively high retransmission persistence, exhibit a 100% reliability, whereas the low-persistence increases the give-up to abandon the retransmission when the frame loss rate increases. In case of the method using a fixed retransmission persistence, when the frame loss rate increases, the number of actual retransmission increases and the frame throughput of the transmitter decreases, so that the method falls into a congestion. The proposed method decreases the retransmission persistence, so the give-up of abandoning the retransmission increases, but it can operate more stably even when the state of the wireless link is unstable.

TABLE 1
Comparison of the Number of Frame Loss
Offered load = 0.8, the total number of arrived frames = 230335

| | | | | Method of Dynamically | |
|---|---|---|---|---|---|
| | | | | Managing a | |
| | | | | Retransmission | |
| | Perfectly- | | | Persistence according | |
| Frame | persistence | Low-persistence | | to the Present Invention | |
| Loss Rate | Loss | Loss | Give-up | Loss | Give-up |
| 0.1 | 0 | 0 | 1 | 0 | 0 |
| 0.02 | 0 | 0 | 1 | 0 | 0 |
| 0.03 | 0 | 0 | 5 | 0 | 0 |
| 0.04 | 0 | 0 | 15 | 0 | 0 |
| 0.05 | 0 | 0 | 24 | 0 | 0 |
| 0.06 | 0 | 0 | 48 | 0 | 0 |
| 0.07 | 0 | 0 | 79 | 0 | 0 |
| 0.08 | 0 | 0 | 119 | 0 | 0 |
| 0.09 | 0 | 0 | 179 | 0 | 0 |
| 0.01 | 0 | 0 | 227 | 0 | 0 |

| | | | | |
|---|---|---|---|---|
| 0.2 | Congestion | Congestion | 0 | 39326 |

| 0.3 | Congestion |
|---|---|
| 0.4 | |
| 0.5 | |

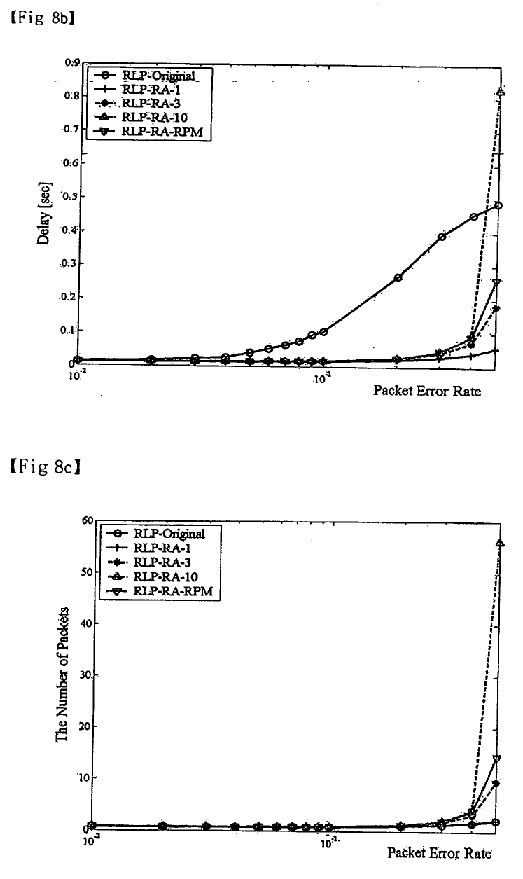

FIGS. 8(a)-(c) show the results of the simulations showing the relationship among packet error rates, reliability, delay time, and average buffer length in an RLP connection.

Herein RLP-Original is the resulting value of the simulation applied to the case where the retransmission persistence is set as 1 without using a reverse ack (RA) method, RLP-RA-1, RLP-RA-3, and RLP-RA 10 are the resulting values of the simulation applied to the fixed retransmission persistence method which sets the retransmission persistence as 1, 3 and 10, respectively, and RLP-RA-RPM is the resulting value of the simulation applied to the case using the dynamic retransmission persistence management according to the present invention.

As shown in FIG. 8(a), the retransmission persistence management method according to the present invention exhibits nearly the same level of reliability as the existing method using a high retransmission persistence (10), and exhibits a more excellent reliability than the existing method using a low retransmission persistence (1 or 3).

In addition, as shown in FIG. 8(b), the RPM method according to the present invention has nearly the same level of delay time as the existing method using a low retransmission persistence (1 or 3), and has a shorter delay time than the existing method using a high retransmission persistence (10).

Also, as shown in FIG. 8(c), the RPM method according to the present invention has nearly the same level of buffer length as the existing method using a low retransmission persistence (1 or 3), and has a very smaller buffer length than the existing method using a high retransmission persistence (10).

Accordingly, the RPM method according to the present invention has an excellent performance in terms of reliability, waiting time, and buffer length compared to the existing method using a fixed retransmission persistence.

The various illustrative logical blocks, steps of flow diagrams, and the functionality described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e. g., a combination of a DSP and a microprocessor, a plurality of microprocessors, one or more microprocessors in conjunction with a DSP core, or any other such configuration.

The steps of flow diagrams and the functionality described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention.

Thus, the present invention is not intended to be limited to the embodiments shown herein but is to be accorded the widest scope consistent with the principles and novel features disclosed herein.

### REFERENCES CITED

[1] G. Fairhurst and L. Wood, “Advice to Link Designers on Link Automatic Repeat Request (ARQ),” RFC 3366, August 2002.

[2] Don Towsley and Jack K. Wolf, “On the Statistical Analysis of Queue Lengths and Waiting Times for Statistical Multiplexers with ARQ Retransmission Schemes,” IEEE/ACM Transactions on Networking, vol. com-27, no.4, April 1979.

[3] Shu Lin, Daniel J. Costello. Jr and Michael J. Miller, “Automatic-Repeat-Request Error Control Schemes,” IEEE Communications Magazine, vol. 22, no. 12, 1984.

[4] Lin, S. and D. Costello, Error Control Coding: Fundamentals and Applications, Prentice Hall, 1993.

[5] Kwang-Sik Kim, Dong-Min Kim, Beum-Joon Kim and Jaiyong Lee, “Improving TCP performance using the adaptive link layer retransmission algorithm over wireless channel,” ICT'2003, February 2003.

[6] William Stallings, High-Speed Networks and Internets, 2nd Ed., Prentice Hall, 2002.

[6] William Stallings, High-Speed Networks and Internets, 2nd Ed., Prentice Hall, 2002.

[8] J. Robinson, “Reliable Link Layer Protocols,” RFC 935, January 1985.

We claim:

1. A method for dynamically managing a retransmission persistence in an automatic repeat request (ARQ) system, comprising the steps of:
measuring the number of frames in a buffer of a transmission node; and
managing the retransmission persistence according to the number of frames in the buffer of the transmission node.

2. The method of claim 1, wherein said step of managing the retransmission persistence comprises the steps of:
comparing the number of frames in the buffer of the transmission node with a predetermined threshold value; and
reducing the retransmission persistence when the number of frames of the buffer of the transmission node exceeds said threshold value, and increasing the retransmission persistence when the number of frames of the buffer is less than said threshold value.

3. The method of claim 1 or 2, wherein said method further comprises the steps of:
measuring transmission delay of frame;
comparing said measured transmission delay value with a maximum allowance delay value; and
reducing the retransmission persistence when the transmission delay value exceeds the maximum allowance delay value, and increasing the retransmission persistence when the transmission delay value is less than the maximum allowance delay value.

4. The method of claim 3, wherein at said step of measuring the transmission delay, the transmission delay value depends on the number (n) of frames in the buffer, the retransmission persistence (p), and round trip delay time (r).

5. The method of claim 4, wherein the transmission delay value are determined by the multiplication (n*p*r) with the number (n) of frames in the buffer, the retransmission persistence (p) and the round trip delay time (r).

6. The method of claim 2, wherein said threshold value is an overflow threshold value.

7. The method of claim 3, wherein said maximum allowance delay value varies depending on the kind of data to be transmitted or on whether or not the data to be transmitted are real-time data.

8. The method of claim 1 or 2, wherein said automatic repeat request (ARQ) system is a stop-and-wait ARQ system.

9. A method for dynamically managing a retransmission persistence in a sliding window ARQ system, comprising the steps of:
measuring the number of frames in a transmission buffer of a transmission node;
measuring the number of frames in a retransmission buffer of the transmission node; and
managing the retransmission persistence according to the number of frames of said transmission buffer and the number of frames in said retransmission buffer.

10. The method of claim 9, wherein said step of managing the retransmission persistence further comprises the steps of:
comparing the number of frames in said transmission buffer with a predetermined threshold value; and
reducing the retransmission persistence when the number of frames in said transmission buffer exceeds said threshold value as a result of said comparison.

11. The method of claim 9 or 10, said method further comprising the steps of:
measuring a transmission delay of frame;
comparing the measured transmission delay value with a maximum allowance delay value; and
reducing the retransmission persistence when the retransmission delay value exceeds the maximum allowance delay value, and increasing the retransmission persistence when the transmission delay value is less than the maximum allowance delay value.

12. The method of claim 11, wherein at said step of measuring the transmission delay, the transmission delay value depends on the number of frames in the transmission buffer, the number of frames in the retransmission buffer, and the round trip delay time.

13. The method of claim 12, wherein the number of frames of said retransmission buffer depends on the retransmission persistence and frame error rate.

14. The method claim 12, wherein the transmission delay value further depends on a resequencing delay time.

15. The method of claim 9 or 10, wherein said automatic repeat request (ARQ) system is a selective repeat ARQ system.

16. The method of claim 11, wherein said maximum allowance delay value varies depending on the kind of data to be transmitted or on whether the data to be transmitted are real-time data.

17. A method for dynamically managing a retransmission persistence in an automatic repeat request (ARQ) system, comprising the steps of:
measuring the input time of the frame that is inputted into a transmission buffer of a transmission node;
measuring the time of receiving ACK with respect to said inputted frame from the receiving node;
calculating the time (delay time) between said input time and said time of receiving ACK;
comparing said delay time with the maximum allowance delay time; and
managing the retransmission persistence according to the result of said comparison.

18. The method of claim 17, wherein said step of managing the retransmission persistence reduces the retransmission persistence when said delay time exceeds the maximum allowance delay time, and increases the retransmission persistence when said delay time is less than the maximum allowance delay time.

19. An apparatus for dynamically managing a retransmission persistence in an automatic repeat request (ARQ) system, comprising:
a transmission buffer for sequentially storing frames to be transmitted;
and a retransmission persistence management unit for managing the retransmission persistence according to the number of frames in the transmission buffer.

20. The apparatus of claim 19, wherein said retransmission persistence management unit comprises
a measurement unit for measuring the number of frames in the transmission buffer;
a first comparator for comparing the number of frames in the transmission buffer with a predetermined first threshold value;
a calculation unit for calculating the transmission delay time; and
a second comparator for comparing the transmission delay time with a predetermined second threshold value.

21. The apparatus of claim 20, wherein said first threshold value corresponds to the maximum number of frames in the buffer which is set in order to prevent an overflow of the buffer,
and said second threshold value corresponds to the maximum allowance delay time.

22. The apparatus of claim 20 or 21, wherein said retransmission persistence management unit further comprises a controller
which reduces the retransmission persistence when the number of frames in said transmission buffer exceeds said first threshold value,
and manages the retransmission persistence according to the result of said second comparison when the number of frames in said transmission buffer is less than said first threshold value.

23. The apparatus for dynamically managing a retransmission persistence in an automatic repeat request (ARQ) system according to claim 22,
wherein said controller reduces the retransmission persistence when the transmission delay time exceed the second threshold value, and increases the retransmission persistence when the transmission delay time is less than the second threshold value.

24. The of claim 20 or 21, wherein said apparatus further comprises a retransmission buffer for storing the retransmission frames for retransmitting lost frames.

25. An apparatus for dynamically managing a retransmission persistence in an automatic repeat request (ARQ) system, comprising:
a measurement unit for measuring a time interval between the input time of the frames inputted into the transmission buffer of the transmission node and the time of receiving ACT with respect to said inputted frames from the receiving node;
a comparator for comparing said time interval with the maximum allowance delay time; and
a controller for managing the retransmission persistence according to the result of said comparison.

26. The apparatus of claim 25, wherein said controller reduces the retransmission persistence when said time interval exceeds the maximum allowance delay time, and increases the retransmission persistence when said times interval is less than the maximum allowance time delay.
